(19) United States
(12) Patent Application Publication
(10) Pub. No.: US 2009/0245602 A1
(43) Pub. Date: Oct. 1, 2009

(54) Device and Method for Recording and Documenting Three-Dimensional Images of the Ocular Fundus

(76) Inventors: Frank Teige, Jena (DE); Detlef Biernat, Jena (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 12/083,785

(22) PCT Filed: Oct. 16, 2006
(86) PCT No.: PCT/EP2006/009950

§ 371 Date: Apr. 18, 2008

(30) Foreign Application Priority Data
Oct. 20, 2005 (DE) 10 2005 050 252.0

(51) Int. Cl. G06K 9/00; H04N 13/00

(52) U.S. Cl. 382/128; 348/42; 348/E13.001

(57) ABSTRACT

The present invention is directed to a solution for ophthalmologic diagnostics in which stereo images of the human fundus are evaluated. The device according to the invention comprises a plane-parallel plate of known thickness which is arranged in front of the front objective of an ophthalmologic device, an adjusting mechanism, an image recording device, and a control unit. The plane-parallel plate can occupy any angular positions. After determining an optimal deflection angle αₒₚₜ, the plane-parallel plate is moved into the other optimal position −αₒₚₜ, and an image of the fundus is recorded in both positions by the image recording device and is stored in the storage of the control unit for evaluation and/or archiving. While the proposed solution is preferably provided for fundus cameras, it can also be used in principle for other ophthalmologic devices. The proposed solution is appreciably simpler to manage compared to the prior art and ensures that the individual conditions of each patient are taken into account in an optimal manner and that the maximum possible stereo effect is always available for the diagnosis.

### CROSS-REFERENCE TO RELATED APPLICATIONS

This is a national phase application of International Application No. PCT/EP2006/009950, filed Oct. 16, 2006 which claims priority of German Application No. 10 2005 050 252.0, filed Oct. 20, 2005, the complete disclosures of which are hereby incorporated by reference.

### FIELD OF THE INVENTION

The present invention is directed to a solution for ophthalmologic diagnostics in which stereo images of the human fundus are recorded, documented and correspondingly evaluated.

### DESCRIPTION OF THE RELATED ART

There are essentially two different methods for recording stereo images according to the known prior art. In the so-called simultaneous method, the two stereo images are recorded simultaneously over separate optical channels; in the sequential method, the two images are recorded successively.

As the solution proposed herein is not based on a simultaneous method, such methods will not be discussed further in the following assessment of the prior art.

In the sequential method, it must be ensured that the two images are recorded successively from correspondingly different viewing angles. The stereo character is not generated until the recordings made at different recording positions with respect to the optical axis are superimposed.

In a first variant of the solution, the entire ophthalmologic device is displaced in two different positions between the two recordings of the fundus for generating a corresponding stereo base while observing the patient's eye to be photographed. In so doing, it must be ensured that the optical axis of the ophthalmologic device remains parallel to the starting position as the ophthalmologic device is displaced and that the displacement path is not too great. When the displacement path is too great, the illumination of the fundus area to be photographed may be insufficient through the illumination pupil and its edge areas can be cut off.

Various manufacturers offer ophthalmologic devices having a fixed displacement path that is realized by levers or knobs in order to minimize incorrect settings due to individual influence.

For example, TOPCON—Medical Systems Inc. offers a fundus camera with variable angles of coverage (model TRC-50VT) having an adjusting knob for displacing the fundus camera in the two recording positions. By actuating the knob, the entire fundus camera is displaced by a previously determined displacement path along a rail into the respective end positions.

In another variant of the solution in order to generate a corresponding stereo base, a plane-parallel plate of defined thickness arranged in front of the front objective of the fundus camera is tilted by a fixed amount so as to produce the required parallel beam offset. Also, the complicated adjustment is replaced by a mechanism. This way of generating a parallel beam offset for stereo photography is also known as Allen stereo separation and is described in greater detail in [1].

The sequential methods known from the prior art have the drawback that either relatively extensive experience and training is required for a manual adjustment or that the individual, concrete conditions such as, e.g., pupil size, are not taken into account in the mechanical adjusting processes because a fixedly adjusted displacement path is always implemented. Accordingly, the quality of the stereo recordings, i.e., the stereoscopic effect, is not optimal and the expected aid to diagnosis of certain pathology images is realized only conditionally if at all.

References:

[1] P. J. Saine, M. E. Tyler, “Ophthalmic Photography: A Textbook of Fundus Photography, Angiography and Electronic Imaging”, Butterworth Heinemann, 1996, pages 88 to 92 (ISBN 0-7506-9793-8)

### OBJECT AND SUMMARY OF THE INVENTION

It is the primary object of the present invention to develop a solution for recording and documenting stereo images of the fundus in which individual influencing variables are taken into account to the greatest extent, and which therefore makes it possible to make optimal use of the stereoscopic effect for improved diagnosis of pathology images.

According to the invention, this object is met in a device for recording and documenting stereo images of the fundus comprising a plane-parallel plate of known thickness which is arranged in front of the front objective of an ophthalmologic device. An adjusting mechanism for defined tilting of the plane-parallel plate, an image recording device and a control unit are provided. The plane-parallel plate can occupy any angular positions relative to the optical axis of the ophthalmologic device. After determining an optimal deflection angle αₒₚₜ, the plane-parallel plate is moved into the other optimal position at −αₒₚₜ, and an image of the fundus is recorded in both positions by the image recording device and is stored in the control unit for evaluation and/or archiving.

The object is also met in a method for recording and documenting stereo images of the fundus comprising the step of arranging a plane-parallel plate of known thickness in front of the front objective of an ophthalmologic device which can occupy defined angular positions relative to the optical axis by means of an adjusting mechanism and, after determining an optimal deflection angle αₒₚₜ, moving the plane-parallel plate into the two positions αₒₚₜ and −αₒₚₜ. The method also includes the step of recording an image of the fundus in both positions by an image recording device and supplying the image to and/or storing said image in a control unit for evaluation and/or archiving.

The device according to the invention for recording and documenting stereo images of the fundus comprises a plane-parallel plate of known thickness which is arranged in front of the front objective of an ophthalmologic device, an adjusting mechanism for defined tilting of the plane-parallel plate, an image recording device, and a control unit. The plane-parallel plate can occupy any angular positions relative to the optical axis of the ophthalmologic device, wherein, after determining an optimal deflection angle αₒₚₜ, the plane-parallel plate is moved into the other optimal position at −αₒₚₜ, and an image of the fundus is recorded in both positions by the image recording device and is stored in the storage of the control unit for evaluation and/or archiving.

Although the proposed solution is provided for the recording and documentation of stereo images of the fundus and is preferably applied in a fundus camera, the solution can also be used in principle for other ophthalmologic devices.

The invention will be described more fully in the following with reference to embodiment examples.

### BRIEF DESCRIPTION OF THE DRAWINGS

In the drawings:

FIG. 1 shows possible positions of the illumination rings in the dilated pupil of the patient for stereo recordings;

FIG. 2 shows the integration of the inventive device in a fundus camera; and

FIG. 3 shows the mirror-symmetric positions of the plane-parallel plate for implementing stereo recordings.

### DESCRIPTION OF THE PREFERRED EMBODIMENTS

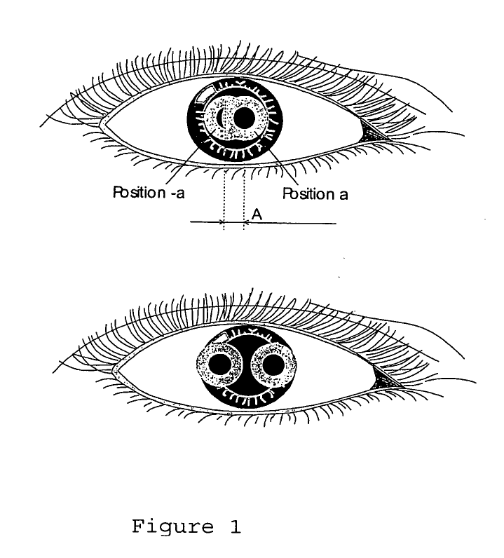

In the proposed solution, an individual adjustment is possible by taking into account the specific conditions of the eye to be imaged, for example, its pupil size. FIGS. 1a and 1b show possible positions of the ring illuminations for stereo recordings in the dilated pupil of the patient. While the position of the ring illuminations in FIG. 1a is optimal, the ring illuminations according to FIG. 1b result in an insufficient illumination of the area of the fundus to be photographed, particularly its edge areas.

In order to adjust the optimal deflection angle αₒₚₜ, the plane-parallel plate has an adjusting mechanism which is preferably constructed as a stepper motor. The optimal deflection angle αₒₚₜ is achieved when the fundus is sufficiently illuminated at a maximum deflection angle αₘₐₓ for an image recording. Any other angle α or −α can be adjusted between the two maximum deflection angles (αₘₐₓ and −αₘₐₓ), the angle 260 between the two selected end positions at αₘₐₓ and −αₘₐₓ being an equivalent for the stereo base A with which the associated pair of images was recorded.

In a first advantageous construction, the control unit has a user control for setting and/or changing the angular position α of the plane-parallel plate in a defined manner and another user control for quickly swiveling the plane-parallel plate into the mirror-symmetric positions αₒₚₜ and −αₒₚₜ or into the symmetric positions α_{corr} and −α_{corr} which are corrected by a previously defined value.

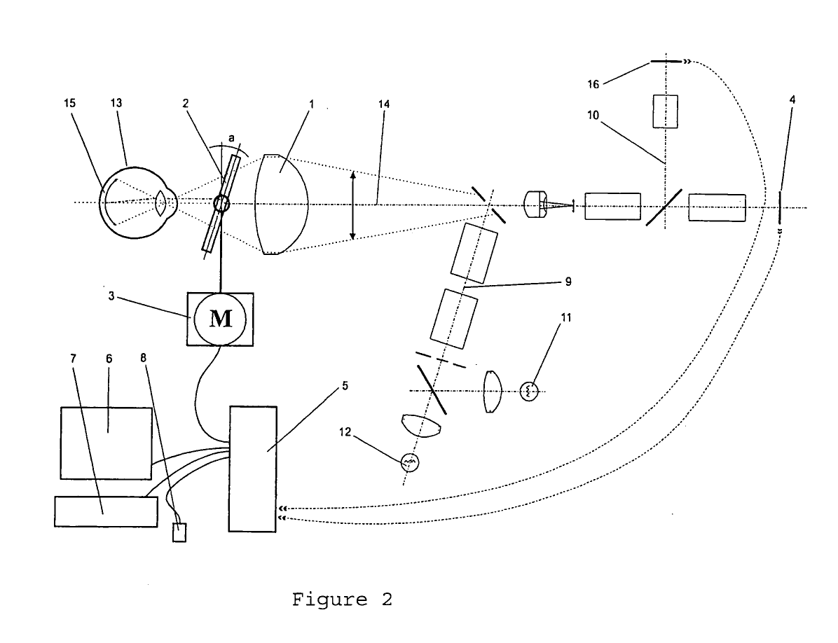

In a second advantageous construction, the ophthalmologic device is a fundus camera which preferably has a flash illumination in addition to a continuous illumination. FIG. 2 shows the integration of the inventive device in a fundus camera.

The device according to the invention comprises a plane-parallel plate 2 of known thickness which is arranged in front of the front objective 1 of a fundus camera, a stepper motor 3 serving as an adjusting mechanism for defined tilting of the plane-parallel plate 2, a digital image sensor 4, and a computer 5 serving as a control unit and having a monitor 6, keyboard 7 and a mouse 8. The illumination beam path 9 and the observation beam path 10 are folded in the drawing plane for the sake of a clearer illustration. The fundus camera has, in addition to a continuous illumination source 11, an additional flash illumination source 12 for photographic recording. Starting from the illumination source 11 arranged in the illumination beam path 9, the patient's eye 13 is illuminated via the front objective 1 arranged in the documentation beam path 14 and via the plane-parallel plate 2. The fundus 15 of the illuminated eye 13 of the patient is in turn imaged on the digital image sensor 4 by the plane-parallel plate 2 arranged in the documentation beam path 14 and by the front objective 1. The existing observation beam path 10 can also have a digital image sensor 16 as a rangefinder camera whose image is sent, e.g., to the monitor 6 for observation.

The parallel beam offset required for stereo photography is generated by the stepper motor 3 through a defined tilting of the plane-parallel plate 2. The stepper motor 3 is controlled by means of the keyboard 7 and/or mouse 8 of the computer 5. Images of the fundus 15 are recorded by the digital image sensor 4 in the optimal deflection angles αₒₚₜ and −αₒₚₜ and sent to the computer 5.

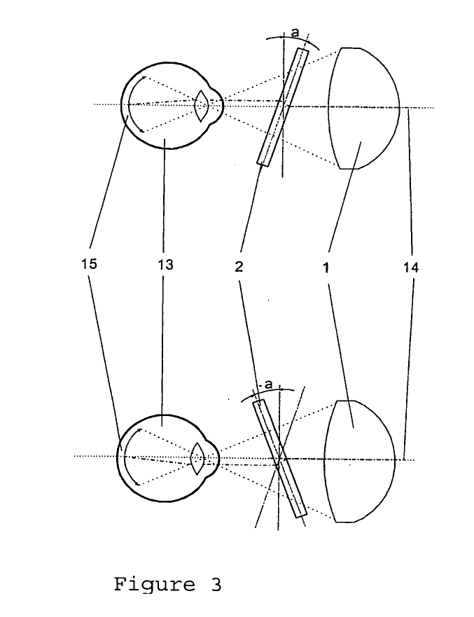

FIG. 3 shows the position of the plane-parallel plate 2 for realizing the two stereo recordings. The parallel beam offset required for stereo photography is generated by a defined tilting of the plane-parallel plate 2 arranged in front of the front objective 1. Two stereo recordings of the fundus 1 are made from the illuminated eye 13 of the patient at different angular positions of the plane-parallel plate 2. The angle 2α between the two selected end positions represents an equivalent for the stereo base A with which the associated pair of images was recorded.

In a particularly advantageous construction, the plane-parallel plate 2 has another adjusting mechanism by which it can be swiveled out of or into the documentation beam path 14 in front of the front objective 1 of the fundus camera.

In the method, according to the invention, for recording and documenting stereo images of the fundus, a plane-parallel plate of known thickness which is arranged in front of the front objective of an ophthalmologic device can occupy defined angular positions relative to the optical axis by means of a stepper motor serving as an adjusting mechanism and, after an optimal deflection angle αₒₚₜ is determined, is moved into the two positions αₒₚₜ and −αₒₚₜ. In both positions, an image of the fundus is recorded by an image recording device, preferably a digital image sensor, and is supplied to and/or stored in the storage of the control unit for evaluation and/or archiving. The ophthalmologic device can be a fundus camera and can have a flash illumination in addition to a continuous illumination.

To determine the optimal deflection angle αₒₚₜ, the deflection angle α of the plane-parallel plate is increased by means of the stepper motor until reaching the precise angle at which an optimal illumination of the fundus of the patient's eye is first achieved. This angle corresponds to the optimal deflection angle αₒₚₜ.

Using user controls of the control unit, the angular position α of the plane-parallel plate can be adjusted and/or changed in a defined manner by means of the stepper motor. Further, it is possible to swivel the plane-parallel plate quickly into the mirror-symmetric positions αₒₚₜ and −αₒₚₜ or into the mirror-symmetric positions α_{corr} and −α_{corr} that are corrected by a previously defined value. A computer with a monitor, keyboard and mouse preferably serves as a control unit. The angular position a of the plane-parallel plate is adjusted or changed by means of corresponding buttons on the user interface of the PC (keyboard, mouse, or the like). For example, the mirror-symmetric position −α associated with this position is adjusted by pressing a button.

First, the precise location in the patient's pupil where an optimal illumination of the fundus, in particular its edge areas, is achieved is found for each patient at maximum deflection αₘₐₓ of the plane-parallel plate. By pushing a button, the mirror-symmetric position −αₘₐₓ of the plane-parallel plate is adjusted and monitored so as to ascertain whether or not an optimal illumination of the fundus is also achieved in this case. This monitoring process is carried out under continuous illumination, preferably under halogen lamp illumination.

When the illumination of the fundus has the desired quality in both positions αₘₐₓ and −ₘₐₓ, the two stereo recordings are initiated one after the other, preferably by pressing only once on the “trigger” button. When the trigger button is actuated, the computer controls the actuating motor which first rotates the plane-parallel plate into position αₘₐₓ and activates the flash lamp for the image recording. The resulting image documented in this way is provided with an identifier for the corresponding position (αₘₐₓ) and is stored in the computer.

The plane-parallel plate is then automatically moved into the second position −αₘₐₓ by the stepper motor, the flash lamp is activated again, and the second resulting image is documented and stored in the computer so as to be provided with an identifier for the corresponding position (−αₘₐₓ).

However, if an optimal illumination is not achieved already by the control adjustment in the second position −αₘₐₓ, the deflection angle α of the plate and, therefore, the stereo base is reduced by a defined, subjectively determinable amount by means of the button on the user interface of the computer. The procedure described above is then repeated until the angular amount α or −α at which a sufficient illumination of the fundus is achieved in the two end positions (position αₒₚₜ and −αₒₚₜ) has been found. When the maximum possible stereo base for this specific patient has been determined, the two stereo images are recorded.

In this way, it is ensured for each individual patient that the maximum possible stereo base is used for the recording of the pair of stereo images, i.e., that the maximum possible stereo impression is available for the diagnosis.

The device and method according to the invention for recording and documenting stereo images of the fundus provide a solution which is appreciably simpler to manage compared to the prior art and which ensures that the individual conditions of each patient are taken into account in an optimal manner. Therefore, the maximum possible stereo effect is always available for the diagnosis.

While the foregoing description and drawings represent the present invention, it will be obvious to those skilled in the art that various changes may be made therein without departing from the true spirit and scope of the present invention.

What is claimed is:

1-18. (canceled)

19. A device for recording and documenting stereo images of the fundus comprising:
a plane-parallel plate of known thickness which is arranged in front of the front objective of an ophthalmologic device;
an adjusting mechanism for defined tilting of the plane-parallel plate;
an image recording device;
a control unit;
said plane-parallel plate can occupy any angular positions relative to the optical axis of the ophthalmologic device; and
wherein, after determining an optimal deflection angle αₒₚₜ, the plane-parallel plate is moved into the other optimal position at −αₒₚₜ, and an image of the fundus is recorded in both positions by the image recording device and is stored in the control unit for evaluation and/or archiving.

20. The device according to claim 19, wherein the ophthalmologic device preferably has a flash illumination in addition to a continuous illumination.

21. The device according to claim 19, wherein the ophthalmologic device is a fundus camera.

22. The device according to claim 19, wherein the adjusting mechanism is a stepper motor.

23. The device according to claim 19, wherein the image recording device is a digital image sensor.

24. The device according to claim 19, wherein the optimal deflection angle αₒₚₜis achieved when the fundus is sufficiently illuminated at a maximum deflection angle αₘₐₓ for an image recording.

25. The device according to at claim 19, wherein the control unit has a user control for setting and/or changing the angular position a of the plane-parallel plate in a defined manner and another user control for quickly swiveling the plane-parallel plate into the mirror-symmetric positions αₒₚₜ and −αₒₚₜ.

26. The device according to claim 19, wherein the control unit has an additional user control for quickly swiveling the plane-parallel plate into the mirror-symmetric positions α_{corr} and −α_{corr} which are corrected by a previously defined value.

27. The device according to claim 19, wherein the plane-parallel plate can be swiveled out of or into the beam path in front of the front objective of the ophthalmologic device by another adjusting mechanism.

28. A method for recording and documenting stereo images of the fundus, comprising the steps of:
arranging a plane-parallel plate of known thickness in front of the front objective of an ophthalmologic device which can occupy defined angular positions relative to the optical axis by means of an adjusting mechanism; and,
after determining an optimal deflection angle αₒₚₜ, moving the plane-parallel plate into the two positions αₒₚₜ and −αₒₚₜ; and,
recording an image of the fundus in both positions by an image recording device and supplying said image to and/or storing said image in a control unit for evaluation and/or archiving.

29. The method according to claim 28, wherein the ophthalmologic device preferably has a flash illumination in addition to a continuous illumination.

30. The method according to claim 28, wherein the ophthalmologic device is a fundus camera.

31. The method according to claim 28, wherein a stepper motor is used as adjusting mechanism.

32. The method according to claim 28, wherein a digital image sensor (4) is used for the image recording.

33. The method according to claim 28, wherein the deflection angle α of the plane-parallel plate is increased until the optimal deflection angle αₒₚₜ is achieved, which corresponds to an illumination of the fundus sufficient for the image recording.

34. The method according to claim 28, wherein the angular position α of the plane-parallel plate can be adjusted and/or changed in a defined manner and the plane-parallel plate can be quickly swiveled into the mirror-symmetric positions αₒₚₜ and −αₒₚₜ by user controls of the control unit.

35. The method according to claim 28, wherein the plane-parallel plate can be quickly swiveled into the mirror-symmetric positions α_{corr} and −α_{corr}, which are corrected by a previously defined value, by another user control of the control unit.

36. The method according to claim 28, wherein the plane-parallel plate can be swiveled out of or into the beam path in front of the front objective of the ophthalmologic device by means another adjusting mechanism.
